(19) United States
(12) Patent Application Publication
(10) Pub. No.: US 2020/0201919 A1
(43) Pub. Date: Jun. 25, 2020

(54) SYSTEM, METHOD, AND PROGRAM FOR GENERATING URL ASSOCIATED WITH ARTICLE

(71) Applicant: OPTiM Corporation, Saga-shi (JP)

(72) Inventor: Shunji SUGAYA, Tokyo (JP)

(21) Appl. No.: 15/754,025

(22) PCT Filed: Nov. 30, 2016
(86) PCT No.: PCT/JP2016/085568

§ 371 Date: Feb. 21, 2018

(51) Int. Cl. G06F 16/958; G06F 16/955

(52) U.S. Cl. CPC G06F 16/958; G06F 16/9566

(57) ABSTRACT

An objective of the present invention is to provide a system, a method, and a program for generating a URL associated with an article that acquire a predetermined keyword from the process of an article and generate the URL of a web content associated with the article. The present invention is a system for generating a URL associated with an article, including: a management unit that classifies a process of producing an article into a plurality of processes and manages the classified processes; a memory unit that associates and stores each of the plurality of processes with a keyword; a selection unit that receives a process selected from the plurality of processes; an acquisition unit that acquires the keyword associated with the selected process; and a generation unit that generates the URL of a web content associated with the article by using the acquired keyword.

### TECHNICAL FIELD

The present invention relates to a system, a method, and a program for generating a uniform resource locator (hereinafter referred to as “URL”) associated with an article.

### BACKGROUND ART

Recently, a URL has been used as a symbol string to identify a resource in the Internet. For example, the URL generation method that shortens the length of the bar code by encoding and compressing the characters that often appears in the URL when a URL is converted into a bar code is provided (Patent Document 1).

### CITATION LIST

### Patent Literature

Patent Document 1: JP H10-177613 A

### SUMMARY OF INVENTION

However, the URL generation method of Patent Document 1 simply generates a URL, which does not respond the needs of manufacturing industries, etc. Thus, the method of generating a URL for the purpose of each web page is desired. For example, in manufacturing industries, a form or a web page for sharing that is associated with each process of producing an article, specifically; each manufacturing process is generally required. Therefore, a method for generating a URL unique to each process of an article or a service is demanded.

In view of the above-mentioned problem, an objective of the present invention is to provide a system, a method, and a program for generating a URL associated with an article that acquire a predetermined keyword from the process of an article and generate the URL of a web content associated with the article.

The present invention is a system for generating a URL associated with an article, including: a management unit that classifies a process of producing an article into a plurality of processes and manages the classified processes; a memory unit that associates and stores each of the plurality of processes with a keyword; a selection unit that receives a process selected from the plurality of processes; an acquisition unit that acquires the keyword associated with the selected process; and a generation unit that generates the URL of a web content associated with the article by using the acquired keyword.

The present invention is also a method for generating a URL associated with an article, including the steps of classifying a process of producing an article into a plurality of processes and managing the classified processes; associating and storing each of the plurality of processes with a keyword; receiving a process selected from the plurality of processes; acquiring the keyword associated with the selected process; and generating the URL of a web content associated with the article by using the acquired keyword.

The present invention is also a program for causing a computer to generate a URL associated with an article, including the steps of classifying a process of producing an article into a plurality of processes and managing the classified processes; associating and storing each of the plurality of processes with a keyword; receiving a process selected from the plurality of processes; acquiring the keyword associated with the selected process; and generating the URL of a web content associated with the article by using the acquired keyword.

According to the present invention, since a URL associated with an article can be generated for each process, a new URL can be easily generated, for example, even if the process of an article is newly added and changed after a URL is generated in a certain process.

### BRIEF DESCRIPTION OF DRAWINGS

FIG. 1 shows the association table for an article, a process, and a keyword that a computer stores.

### DESCRIPTION OF EMBODIMENTS

Embodiments of the present invention will be described below. However, this is illustrative only, and the technological scope of the present invention is not limited thereto.

The system for generating a URL associated with an article generates a URL associated with an article and service (hereinafter referred to as “article” collectively). The system for generating a URL associated with an article includes a management unit, a memory unit, a selection unit, an acquisition unit, and a generation unit that are achieved when the control unit of a computer reads a predetermined program. The system may also include a creation unit and a writing unit. These units may be of an on-premises type, a cloud type, etc. The above-mentioned units may each be achieved by a single computer or two or more computers (e.g., a server and a terminal).

The management unit classifies the process of producing an article into a plurality of processes and manages the classified processes. The processes are stored by receiving input from the user.

The process lasts until an article is sold. For example, for farm products, the process may be a series of processes until an article is lined up in a store or may be one process in the series of processes. Examples of the process for farm products may include a process of creating an environment for crops (environment process), a process of growing crops (growing process), a process of harvesting crops (harvest process), a process of sorting crops (sort process), a process of distributing crops (distribution process), and a process of selling crops (sale process).

The process may be subdivided. For example, the soil process may change the property information, the state, etc., of the soil in which seeds are scattered, and the growing process may change the property information, the state, etc., of the growing crops. Furthermore, for example, the harvest process may change the property information, the state, etc., of the harvested crops, and the sort process may change the property information, the state, etc., of the sorted crops. Furthermore, for example, the distribution process may change the property information, the state, etc., of the distribution for the crops, and the sale process may change the property information, the state, etc., of the store that sells the crops.

For example, the process until “lacquerware” is lined up in a store as an article will be described below. Lacquerware is classified into the lacquer preparation process, the lacquerware formation process, the lacquer coating process, the sort process, the distribution process, the sale process, etc., and then managed. The lacquer preparation process indicates the property information, the preparation procedure, etc., of lacquer. The lacquerware formation process indicates the property information, the formation procedure, etc., of lacquerware. The sort process indicates the property information and the sorting procedure, etc., of the sorted lacquerware. The distribution process indicates the procedure, etc., of distribution for the lacquerware. The sale process indicates the sale procedure, etc., of the store that sells the lacquerware.

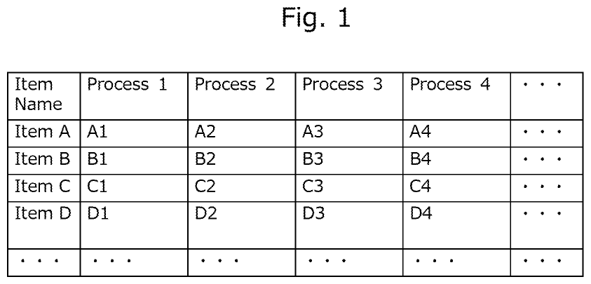

The memory unit associates and stores an article and each of a plurality of processes with a keyword in the table as shown in FIG. 1 in response to input from the user

For example, a computer stores a plurality of processes and keywords associated with the respective processes every article as shown in FIG. 1. In FIG. 1, the keyword associated with the process 1 of the article A is A1, and the keyword associated with the process 3 of the article B is B3. The keyword may have regularity as shown in FIG. 1 or may be random, as long as it is associated with each process. The keyword may be input from the user or may be set by a computer to be associated with the process input from the user.

The computer may extract any characters based on the article name and the process name and combine the extracted characters to generate a keyword. In this case, the extracted characters do not function as a URL if duplicated. Accordingly, the extracted characters are compared with the previous determined characters not to generate a duplicate keyword. To avoid a duplicate keyword from being generated, the order of the keyword may be changed, or the number of the process, etc., may be added to the keyword.

Moreover, the best keyword may be learned and stored by machine learning. Specifically, for an article, a keyword associated with the process 1 is received from the user. Then, the combination of the input keyword and the process is learned. If the same process is input for the article, the learned keyword is used.

The selection unit receives a process that the user selects from the plurality of processes. Specifically, the table as shown in FIG. 1 is displayed to the user to receive a selected process desired to generate a URL. More specifically, a process desired for the article B, for example, the process 3 shown in FIG. 1 is selected and received.

The acquisition unit acquires a keyword associated with the process selected by the selection unit. For example, in FIG. 1, if the process selected for the article B is the process 3, B3 is acquired as the associated keyword.

The generation unit generates the URL of the web content associated with an article by using the keyword acquired by the acquisition unit.

For example, in FIG. 1, if the acquired keyword is B3, the URL of the web content associated with the article B is generated by using B3. More specifically, if the domain is “http://www.shouhinkannri.com,” the URL of the web content associated with the article B, for example, “http://www.shouhinkannri.com/B3” is generated by using B3.

After the character string of URL is generated, a computer generates the web content. This may be achieved by generating a predetermined HTML file, etc., and linking the generated file with the URL as the link destination. This process enables the user to access the URL to view the web content associated with the article B.

The selection unit may receive at least two or more processes that the user selects from the plurality of processes. The acquisition unit may acquire the keyword associated with the each selected process. The generation unit may generate the URL of the web content associated with the article by combining the acquired keywords.

For example, in FIG. 1, if the selection unit receives the processes 2, 3, and 4 of the article B, the acquisition unit may acquire the keywords B2, B3, and B4, and the generation unit may combine B2, B3, and B4 to generate the URL. More specifically, if the domain is “http://www.shouhinkannri.com,” a URL, for example, “http://www.shouhinkannri.com/B2B3B4” may be generated by sequentially arranging B2, B3, and B4. Alternatively, “http://www.shouhinkannri.com/4BB32B” may be generated by randomly arranging B2, B3, and B4. This process enables the user to access the URL to view the web content associated with the article B.

The creation unit creates the content for the URL of the viewable web content based on the specific web content input from the user.

The user freely creates the web content by using the web page of traceability of an article, the web coupon of an article, the web pamphlet of an article, etc.

When the content is created, the writing unit receives a location of the web content and a location specified from the user and additionally writes the selected process in the created web content. For example, if the selected processes are the processes 2, 3, and 4 of the article B, the processes 2, 3, and 4 of the article B are written in the web content. More specifically, if the selected processes are for farm products, the content is displayed every process so that it can be used for the traceability of the selected processes, etc.

As the specific algorithm of the above-mentioned machine learning, the nearest neighbor algorithm, the naive Bayes algorithm, the decision tree, the support vector machine, etc. may be used. Furthermore, the machine learning may be the deep learning that generates the feature amount for learning by using the neural network.

To achieve the means and the functions that are described above, a computer (including a CPU, an information processor, and various terminals) reads and executes a predetermined program. For example, the program may be provided through Software as a Service (SaaS), specifically, from a computer through a network or may be provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

What is claimed is:

1. A system for generating a URL associated with an article, comprising:
a management unit that classifies a process of producing an article into a plurality of processes and manages the classified processes;
a memory unit that associates and stores each of the plurality of processes with a keyword;
a selection unit that receives a process selected from the plurality of processes;
an acquisition unit that acquires the keyword associated with the selected process; and
a generation unit that generates the URL of a web content associated with the article by using the acquired keyword.

2. The system according to claim 1, wherein the selection unit receives at least two or more processes that the user selects from the plurality of processes, the acquisition unit acquires the keyword associated with the each selected process, and the generation unit generates the URL of the web content associated with the article by combining the acquired keywords.

3. The system according to claim 1, further comprising a creation unit that creates the web content.

4. The system according to claim 3, further comprising a writing unit that writes the selected process to the created web content.

5. A method for generating a URL associated with an article, comprising the steps of:
classifying a process of producing an article into a plurality of processes and managing the classified processes;
associating and storing each of the plurality of processes with a keyword;
receiving a process selected from the plurality of processes;
acquiring the keyword associated with the selected process; and
generating the URL of a web content associated with the article by using the acquired keyword.

6. A program for causing a computer to generate a URL associated with an article, including the steps of
classifying a process of producing an article into a plurality of processes and managing the classified processes;
associating and storing each of the plurality of processes with a keyword;
receiving a process selected from the plurality of processes;
acquiring the keyword associated with the selected process; and
generating the URL of a web content associated with the article by using the acquired keyword.
